(19) United States
(12) Patent Application Publication
(10) Pub. No.: US 2019/0157832 A1
(43) Pub. Date: May 23, 2019

(54) WAVELENGTH SHIFT CONTROL METHOD AND SYSTEM

(71) Applicant: HUAWEI TECHNOLOGIES CO., LTD., Shenzhen (CN)

(72) Inventors: Xuming Wu, Wuhan (CN); Huafeng Lin, Dongguan (CN); Liming Fang, Shenzhen (CN)

(21) Appl. No.: 16/252,090

(22) Filed: Jan. 18, 2019

Related U.S. Application Data
(63) Continuation of application No. PCT/CN2016/090868, filed on Jul. 21, 2016.

(51) Int. Cl. H01S 3/13; H01S 3/10; H04Q 11/00

(52) U.S. Cl. CPC H01S 3/1301; H04Q 2011/0064; H04Q 11/0067; H01S 3/10015

(57) ABSTRACT

Embodiments of the present invention disclose a wavelength shift control method and system, to implement stable control over temperature of a laser to ensure that a transmit wavelength of the laser is stable in a burst work process of a transmitter and is not shifted to avoid impact on normal work of a PON system with a plurality of wavelength paths. The method includes: generating a burst control signal; sending the burst control signal to a controller; and controlling switch statuses of a laser and a heater according to the received burst control signal, where when a switch of the laser is in an on state, a switch of the heater is in an off state, and when a switch of the laser is in an off state, a switch of the heater is in an on state, so that a temperature of the laser remains stable.

### CROSS-REFERENCE TO RELATED APPLICATIONS

This application is a continuation of International Application No. PCT/CN2016/090868, filed on Jul. 21, 2016, the disclosure of which is hereby incorporated by reference in its entirety.

### TECHNICAL FIELD

The present invention relates to the optical communications field, and in particular, to a wavelength shift control method and system.

### BACKGROUND

A broadband access technology develops rapidly in recent years. A passive optical network (PON) system has been widely popularized and rapidly expanded. An access network requires low costs. In view of this, an access technology with low costs is a main development direction. A wavelength division multiplexing manner is mainly used in the access technology with low costs to implement a high-capacity PON system. For example, an uplink and a downlink of a typical PON system both include four wavelength paths. A 100 GHz distance exists between every two adjacent wavelength paths. Coexistence between wavelengths is implemented using a wavelength multiplexer (WM). The PON system is a point-to-multipoint system. Each optical line terminal (OLT) in the PON system needs to be connected to uplink and downlink services of a plurality of optical network units (ONU). To avoid a conflict between uplink services of the ONU, the PON system works on an uplink in a time division multiplexing manner. After the OLT performs scheduling, only one ONU is allowed to send an uplink service at a moment, and a transmitter needs to be immediately closed after the uplink service is sent, to ensure that work of a next ONU is not interfered. This working mode of the ONU is referred to as a burst transmission mode. When the ONU is in the burst transmission mode, because a drive current is instantaneously added to a laser chip, the drive current causes temperature of the laser chip to rise. After the temperature of the laser chip becomes stable, if a laser is turned off, the temperature of the laser chip is lowered, and then, the temperature of the laser chip changes, causing a shift to a transmit wavelength of the laser. This affects normal work of the ONU and another ONU of an adjacent path. In other words, a wavelength shift affects normal work of a PON system with a plurality of wavelength paths.

A current method for eliminating impact caused by a wavelength shift is as follows: A drive current is reduced to reduce a wavelength shift amount because the wavelength shift amount is directly proportional to the drive current of the laser, to reduce the impact caused by the wavelength shift.

However, if the drive current is reduced, a transmission function of the laser is affected, and the PON system has a relatively high requirement for a transmit power of the laser. Therefore, reducing the drive current affects the normal work of the PON system. It can be learned that the method cannot well eliminate the impact caused by the wavelength shift on the normal work of the PON system with a plurality of wavelength paths.

### SUMMARY

In view of this, a first aspect of the present invention provides a wavelength shift control method. The method is applied to a wavelength shift control system. The system includes Media Access Control (MAC), a controller, and a transmitter. The transmitter includes a laser and a heater, and the laser fits the heater. Heat conducted by the heater to the laser when a switch of the heater is turned on to match heat of the laser when a switch of the laser is turned off. The method includes: generating, by the MAC, a burst control signal; sending, by the MAC, the burst control signal to the controller; and controlling, by the controller, switch statuses of the laser and the heater according to the received burst control signal, where when the switch of the laser is in an on state, the switch of the heater is in an off state, and when the switch of the laser is in an off state, the switch of the heater is in an on state, so that temperature of the laser remains stable.

The switch of the laser and the switch of the heater are both controlled using the burst control signal, to implement stable control over the temperature of the laser, ensure that a transmit wavelength of the laser is stable in a burst work process of a transmitter and is not shifted, and avoid impact on normal work of a PON system with a plurality of wavelength paths. This is different from the prior art.

In one embodiments, the controlling, by the controller, switch statuses of the laser and the heater according to the received burst control signal includes: controlling, by the controller, the switch statuses of the laser and the heater according to a high or low level of the received burst control signal, where when a level of the burst control signal is a high level, the switch of the laser is in the on state, and when a level of the burst control signal is a low level, the switch of the laser is in the off state; or when a level of the burst control signal is a low level, the switch of the laser is in the off state, and when a level of the burst control signal is a high level, the switch of the laser is in the on state.

The switch of the laser and the switch of the heater are both controlled using the high or low level of the burst control signal, to implement stable control over the temperature of the laser, ensure that the laser and the heater alternately work, ensure that a transmit wavelength of the laser is stable in a burst work process of a transmitter and is not shifted, and avoid impact on normal work of a PON system with a plurality of wavelength paths. This is different from the prior art.

In one embodiment, the controller includes a laser current controller and a heater current controller, and the controlling, by the controller, switch statuses of the laser and the heater according to the received burst control signal includes: turning on, by the laser current controller, a current switch of the laser according to the received burst control signal, and turning off, by the heater current controller, a current switch of the heater according to the received burst control signal; or turning off, by the laser current controller, a current switch of the laser according to the received burst control signal, and turning on, by the heater current controller, a current switch of the heater according to the received burst control signal.

The transmitter may further include a semiconductor cooler, and the transmitter controls overall temperature inside the transmitter using the semiconductor cooler, to ensure that the overall temperature inside the transmitter does not change. This is different from the prior art. In addition, the controller includes the laser current controller and the heater current controller. The laser current controller is configured to provide a drive current for the laser, and the heater current controller is configured to provide a drive current for the heater. According to the burst control signal, the drive current of the laser is enabled or disabled by controlling the laser current controller, and the drive current of the heater is enabled or disabled by controlling the heater current controller, to ensure that the heater and the laser alternately work.

In one embodiment, the controller includes a laser current controller and a current switching switch connected to the laser current controller, the current switching switch is configured to connect to an input end of the laser or an input end of the heater, and the controlling, by the controller, switch statuses of the laser and the heater according to the received burst control signal includes: switching, by the laser current controller, the current switching switch to the input end of the laser according to the received burst control signal; or switching, by the laser current controller, the current switching switch to the input end of the heater according to the received burst control signal.

The drive current of the laser and the drive current of the controller are both provided by the laser current controller. This is different from the prior art. When the laser needs to be turned on, the current switching switch is connected to the input end of the laser. In this case, the laser works. When the laser needs to be turned off, the current switching switch is connected to the input end of the heater. In this case, the drive current of the laser is disconnected, and the heater works. In an actual application, the heater may select a resistor connected in parallel for current division, and a size of the drive current of the heater may be adjusted using the resistor connected in parallel. Alternatively, the heater may be serially connected to a proportional current divider, and a size of the drive current of the heater may be adjusted using the proportional current divider.

In one embodiment, the controller is a controller in a primary path of the system, the transmitter is a transmitter in the primary path of the system, and the method further includes: after the primary path is faulty, generating, by the MAC, a protection path control signal; sending, by the MAC, the protection path control signal to a controller in a preset protection path; and controlling, by the controller in the protection path, switch statuses of a laser and a heater in the protection path according to the received protection path control signal, where when a switch of the laser in the protection path is in an on state, the heater in the protection path is in an off state, and when a switch of the laser in the protection path is in an off state, the heater in the protection path is in an on state, so that temperature of the laser in the protection path remains stable.

To ensure stable performance of the system, the protection path is usually reserved on an OLT side. Usually, a transmitter of the protection path is turned off. When the PON system detects that the primary path is faulty, the protection path is initiated, and the MAC generates the protection path control signal and sends the protection path control signal to the controller in the protection path. This is different from the prior art.

In one embodiment, the controller provides a drive current of the heater and a drive current of the laser.

In one embodiment, a ratio of a value for the drive current of the heater to a value for the drive current of the laser is a preset threshold.

A second aspect of the present invention further provides a wavelength shift control method. The method is applied to a wavelength shift control system. The system includes Media Access Control MAC, a controller, and a transmitter. The transmitter includes a laser, a heater, and an optical amplifier, and the laser fits both the heater and the optical amplifier. Heat conducted by the heater to the laser when a switch of the heater is turned on matches heat conducted by the optical amplifier to the laser when a switch of the optical amplifier is turned on. The method includes: generating, by the MAC, a burst control signal; sending, by the MAC, the burst control signal to the controller; and controlling, by the controller, switch statuses of the heater and the optical amplifier according to the received burst control signal, where when the switch of the heater is in an on state, the switch of the optical amplifier is in an off state, and when the switch of the heater is in an off state, the switch of the optical amplifier is in an on state, so that temperature of the laser remains stable.

The heater and the optical amplifier operate alternatively, to ensure that the temperature of the laser does not change, avoiding a wavelength shift. This is different from the prior art.

In one embodiment, the controller provides a drive current of the heater and a drive current of the optical amplifier.

In another embodiment, a ratio of a value for the drive current of the heater to a value for the drive current of the optical amplifier is a preset threshold.

A third aspect of the present invention further provides a wavelength shift control system. The system includes: MAC, a controller, and a transmitter. The transmitter includes a laser and a heater, and the laser fits the heater. Heat conducted by the heater to the laser when a switch of the heater is turned on to match heat of the laser when a switch of the laser is turned off. The MAC is used to: generate a burst control signal, and send the burst control signal to the controller. The controller is configured to control switch statuses of the laser and the heater according to the received burst control signal, where when the switch of the laser is in an on state, the switch of the heater is in an off state, and when the switch of the laser is in an off state, the switch of the heater is in an on state, so that temperature of the laser remains stable.

The switch of the laser and the switch of the heater are both controlled using the burst control signal, to implement stable control over the temperature of the laser, ensure that a transmit wavelength of the laser is stable in a burst work process of a transmitter and is not shifted, and avoid impact on normal work of a PON system with a plurality of wavelength paths. This is different from the prior art.

In one embodiment, the controller is configured to control the switch statuses of the laser and the heater according to a high or low level of the received burst control signal, where when a level of the burst control signal is a high level, the switch of the laser is in the on state, and when a level of the burst control signal is a low level, the switch of the laser is in the off state; or when a level of the burst control signal is a low level, the switch of the laser is in the off state, and when a level of the burst control signal is a high level, the switch of the laser is in the on state.

The switch of the laser and the switch of the heater are both controlled using the high or low level of the burst control signal, to implement stable control over the temperature of the laser, ensure that the laser and the heater alternately work, ensure that a transmit wavelength of the laser is stable in a burst work process of a transmitter and is not shifted, and avoid impact on normal work of a PON system with a plurality of wavelength paths. This is different from the prior art.

In one embodiment, the controller includes a laser current controller and a heater current controller, the laser current controller is configured to turn on a current switch of the laser according to the received burst control signal, and the heater current controller is configured to turn off a current switch of the heater according to the received burst control signal; or the laser current controller is configured to turn off a current switch of the laser according to the received burst control signal, and the heater current controller is configured to turn on a current switch of the heater according to the received burst control signal.

The transmitter may further include a semiconductor cooler, and the transmitter controls overall temperature inside the transmitter using the semiconductor cooler, to ensure that the overall temperature inside the transmitter does not change. This is different from the prior art. In addition, the controller includes the laser current controller and the heater current controller. The laser current controller is configured to provide a drive current for the laser, and the heater current controller is configured to provide a drive current for the heater. According to the burst control signal, the drive current of the laser is enabled or disabled by controlling the laser current controller, and the drive current of the heater is enabled or disabled by controlling the heater current controller, to ensure that the heater and the laser alternately work.

In one embodiment, the controller includes a laser current controller and a current switching switch connected to the laser current controller, the current switching switch is configured to connect to an input end of the laser or an input end of the heater, the laser current controller is configured to switch the current switching switch to the input end of the laser according to the received burst control signal, or the laser current controller is configured to switch the current switching switch to the input end of the heater according to the received burst control signal.

The drive current of the laser and the drive current of the controller are both provided by the laser current controller. This is different from the prior art. When the laser needs to be turned on, the current switching switch is connected to the input end of the laser. In this case, the laser works. When the laser needs to be turned off, the current switching switch is connected to the input end of the heater. In this case, the drive current of the laser is disconnected, and the heater works. In an actual application, the heater may select a resistor connected in parallel for current division, and a size of the drive current of the heater may be adjusted using the resistor connected in parallel. Alternatively, the heater may be serially connected to a proportional current divider, and a size of the drive current of the heater may be adjusted using the proportional current divider.

In one embodiment, there is a current divider on a link of the heater.

In one embodiment, the controller is a controller in a primary path of the system, the transmitter is a transmitter in the primary path of the system, the MAC is further configured to: after the primary path is faulty, generate a protection path control signal, and send the protection path control signal to a controller in a preset protection path, the system further includes the controller in the protection path, and the controller in the protection path is configured to control switch statuses of a laser and a heater in the protection path according to the received protection path control signal, where when a switch of the laser in the protection path is in an on state, the heater in the protection path is in an off state, and when a switch of the laser in the protection path is in an off state, the heater in the protection path is in an on state, so that temperature of the laser in the protection path remains stable.

To ensure stable performance of the system, the protection path is usually reserved on an OLT side. Usually, a transmitter of the protection path is turned off. When the PON system detects that the primary path is faulty, the protection path is initiated, and the MAC generates the protection path control signal and sends the protection path control signal to the controller in the protection path. This is different from the prior art.

In one embodiment, the controller provides a drive current of the heater and a drive current of the laser.

In one embodiment, a ratio of a value for the drive current of the heater to a value for the drive current of the laser is a preset threshold.

A fourth aspect of the present invention further provides a wavelength shift control system. The system includes MAC, a controller, and a transmitter. The transmitter includes a laser, a heater, and an optical amplifier, and the laser fits both the heater and the optical amplifier. Heat conducted by the heater to the laser when a switch of the heater is turned on to match heat conducted by the optical amplifier to the laser when a switch of the optical amplifier is turned on. The MAC is used to: generate a burst control signal, and send the burst control signal to the controller. The controller is configured to control switch statuses of the heater and the optical amplifier according to the received burst control signal, where when the switch of the heater is in an on state, the switch of the optical amplifier is in an off state, and when the switch of the heater is in an off state, the switch of the optical amplifier is in an on state, so that temperature of the laser remains stable.

The heater and the optical amplifier alternatively work, to ensure that the temperature of the laser does not change, avoiding a wavelength shift. This is different from the prior art.

In one embodiment, the controller provides a drive current of the heater and a drive current of the optical amplifier.

In one embodiment, a ratio of a value for the drive current of the heater to a value for the drive current of the optical amplifier is a preset threshold.

In the technical solutions provided in embodiments of the present invention, the switch of the laser and the switch of the heater are both controlled using the burst control signal. When the heat conducted by the heater to the laser when the switch of the heater is turned on matches the heat of the laser when the switch of the laser is turned off, this implements stable control over the temperature of the laser, ensures that the transmit wavelength of the laser is stable in the burst work process of a transmitter and is not shifted, and avoid the impact on the normal work of the PON system with a plurality of wavelength paths.

### BRIEF DESCRIPTION OF DRAWINGS

FIG. 1 is a schematic diagram of an internal structure of a transmitter with a heater according to an embodiment of the present invention;

FIG. 2 is a schematic diagram of an embodiment of a wavelength shift control method according to an embodiment of the present invention;

FIG. 3 is a schematic diagram of control of a specific burst control signal according to an embodiment of the present invention;

FIG. 4 is a schematic diagram of another embodiment of a wavelength shift control method according to an embodiment of the present invention;

FIG. 5 is a schematic structural diagram of a wavelength shift control system according to an embodiment of the present invention;

FIG. 6 is a schematic structural diagram of a circuit in which a drive current of a laser is proportional to a drive current of a heater according to an embodiment of the present invention;

FIG. 7 is another schematic structural diagram of a wavelength shift control system according to an embodiment of the present invention;

FIG. 8 is another schematic structural diagram of a wavelength shift control system according to an embodiment of the present invention;

FIG. 9 is a schematic structural diagram of a wavelength shift control system of a protection path according to an embodiment of the present invention;

FIG. 10 is another schematic structural diagram of a wavelength shift control system of a protection path according to an embodiment of the present invention;

FIG. 11 is another schematic structural diagram of a wavelength shift control system according to an embodiment of the present invention; and

FIG. 12 is a schematic structural diagram of a circuit in which a drive current of a heater is proportional to a drive current of an optical amplifier according to an embodiment of the present invention.

### DESCRIPTION OF EMBODIMENTS

The following describes the technical solutions in the embodiments of the present invention with reference to the accompanying drawings in the embodiments of the present invention. The described embodiments are merely some but not all of the embodiments of the present invention. All other embodiments obtained by persons skilled in the art based on the embodiments of the present invention without creative efforts shall fall within the protection scope of the present invention.

In the specification, claims, and accompanying drawings of the present invention, the terms “first”, “second”, “third”, “fourth”, and the like (if exist) are intended to distinguish between similar objects but do not necessarily indicate a specific order or sequence. It should be understood that the data termed in such a way are interchangeable in proper circumstances so that the embodiments described herein can be implemented in other orders than the order illustrated or described herein. Moreover, the terms “include”, “contain” and any other variants mean to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

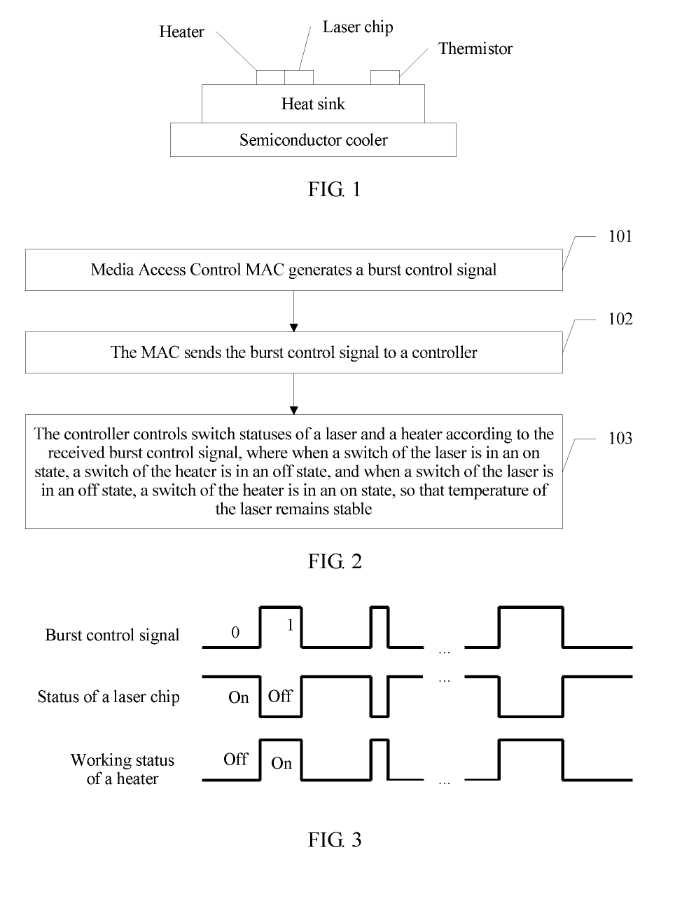

In some embodiments of the present invention, a heater is placed inside a transmitter, for example, a resistive heater. The heater fits a laser chip. A switch of a laser and a switch of the heater are both controlled using a burst control signal, to implement stable control over temperature of the laser, ensure that a transmit wavelength of the laser is stable in a burst work process of a transmitter and is not shifted, and avoid impact on normal work of a PON system with a plurality of wavelength paths. An embodiment of the present invention provides a schematic diagram of an internal structure of a transmitter with a heater. As shown in FIG. 1, a semiconductor cooler, a heat sink, and a thermistor are used to keep overall temperature inside the transmitter unchanged through controlling. The heater and the laser chip may be integrated on a chip, or the transmitter may be placed next to the laser chip in an encapsulation process. The transmitter with the heater needs to complete control over the semiconductor cooler, control over the laser chip, and control over the heater during burst work.

The following describes a wavelength shift control method in some embodiments of the present invention with reference to accompanying drawings.

Referring to FIG. 2, an embodiment of a wavelength shift control method in some embodiments of the present invention includes the following operations.

Operation 101. MAC generates a burst control signal.

In one embodiment, the burst control signal may be generated by the MAC of an ONU end of a PON system based on scheduling of an OLT.

Operation 102. The MAC sends the burst control signal to a controller.

In one embodiment, there may be one or more controllers. This is not limited herein. The controller may include one or more sub-controllers, such as a laser current controller and a heater current controller in the following.

Operation 103. The controller controls switch statuses of a laser and a heater according to the received burst control signal, where when a switch of the laser is in an on state, a switch of the heater is in an off state, and when a switch of the laser is in an off state, a switch of the heater is in an on state, so that temperature of the laser remains stable.

In one embodiment, the burst control signal may be a pulse electrical signal. The pulse electrical signal includes two level statuses (0 and 1). Herein “0” represents a low level, and “1” represents a high level. The two level statuses respectively represent on and off states of the laser.

It should be noted that heat of the laser is related to a drive current of the laser, and heat of the heater is related to a drive current of the heater. A larger drive current indicates more heat. Usually, the drive current of the heater is related to the drive current of the laser. The drive current of the laser is a current required for driving the laser to work, and the drive current of the heater is a current required for driving the heater to work. For a specific laser and a specific heater, a heat conduction relationship between the specific laser and the specific heater is determined. Therefore, as long as it is ensured that heat conducted by the heater to the laser when the switch of the heater is turned on matches (for example, is the same as) heat of the laser when the switch of the laser is turned off, it can be ensured that the temperature of the laser remains stable when the switch of the laser is turned off (the switch of the heater is turned on) and the switch of the laser is turned on (the switch of the heater is turned off). Although heat efficiency of the laser and heat efficiency of the heater may be different, the heat efficiency is positively related to the drive current, for example, in direct proportion. To ensure that the heat conducted by the heater to the laser is consistent with the heat of the laser, usually, it may be ensured that the drive current of the heater is proportional to the drive current of the laser. To be specific, a ratio of a value for the drive current of the heater to a value for the drive current of the laser is a preset threshold. The preset threshold herein is determined based on the heat efficiency and heat conduction efficiency of the laser and the heater, and the preset threshold is determined for the specific laser and the specific heater.

For example, when the switch of the laser is in the off state, in this case, the temperature of the laser is lowered. To ensure that the temperature of the laser remains stable, in this case, the switch of the heater is turned on, so that the temperature of the laser remains stable through heat conduction. Then, when the switch of the laser is in the on state, to ensure that the temperature of the laser remains stable, heating the laser (the heat conduction) needs to be stopped. Therefore, the heater needs to be turned off. In this way, the temperature of the laser can always remain stable, so that no shift is generated.

In one embodiment, the switch of the laser and the switch of the heater are both controlled using the burst control signal, to implement stable control over the temperature of the laser, ensure that a transmit wavelength of the laser is stable in a burst work process of a transmitter and is not shifted, and avoid impact on normal work of a PON system with a plurality of wavelength paths.

In some embodiments of the present invention, that the controller controls switch statuses of a laser and a heater according to the received burst control signal is specifically:

controlling, by the controller, the switch statuses of the laser and the heater according to a high or low level of the received burst control signal, where when a level of the burst control signal is a high level, the switch of the laser is in the on state, and when a level of the burst control signal is a low level, the switch of the laser is in the off state; or when a level of the burst control signal is a low level, the switch of the laser is in the off state, and when a level of the burst control signal is a high level, the switch of the laser is in the on state.

Refer to FIG. 3 for a schematic diagram of control over a specific burst control signal. In FIG. 3, when the burst control signal is at a low level 0, the switch of the laser is in the state, and the switch of the heater is in the off state; and when the burst control signal is at a high level 1, the switch of the laser is in the off state, and the switch of the heater is in the on state.

In one embodiment, the switch of the laser and the switch of the heater are both controlled using a high or low level of the burst control signal, to implement stable control over the temperature of the laser, ensure that the laser and the heater alternately work, ensure that a transmit wavelength of the laser is stable in a burst work process of a transmitter and is not shifted, and avoid impact on normal work of a PON system with a plurality of wavelength paths.

In some embodiments of the present invention, the controller includes the laser current controller and the heater current controller, and that the controller controls switch statuses of a laser and a heater according to the received burst control signal includes:

turning on, by the laser current controller, a current switch of the laser according to the received burst control signal, and turning off, by the heater current controller a current switch of the heater according to the received burst control signal;

or turning off, by the laser current controller, a current switch of the laser according to the received burst control signal, and turning on, by the heater current controller, a current switch of the heater according to the received burst control signal.

In one embodiment, a transmitter may further include a semiconductor cooler, and the transmitter controls overall temperature inside the transmitter using the semiconductor cooler, to ensure that the overall temperature inside the transmitter does not change. In addition, the controller includes the laser current controller and the heater current controller. The laser current controller is configured to provide a drive current for the laser, and the heater current controller is configured to provide a drive current for the heater. According to the burst control signal, the drive current of the laser is enabled or disabled by controlling the laser current controller, and the drive current of the heater is enabled or disabled by controlling the heater current controller, to ensure that the heater and the laser alternately work.

In some embodiments of the present invention, the controller includes the laser current controller and the current switching switch connected to the laser current controller, the current switching switch is configured to connect to an input end of the laser or an input end of the heater, and that the controller controls switch statuses of a laser and a heater according to the received burst control signal includes:

switching, by the laser current controller, the current switching switch to the input end of the laser according to the received burst control signal; or switching, by the laser current controller, the current switching switch to the input end of the heater according to the received burst control signal.

In one embodiment, the drive current of the laser and the drive current of the controller are both provided by the laser current controller. When the laser needs to be turned on, the current switching switch is connected to the input end of the laser. In this case, the laser works. When the laser needs to be turned off, the current switching switch is connected to the input end of the heater. In this case, the drive current of the laser is disconnected, and the heater works. In an actual application, the heater may select a resistor connected in parallel for current division, and a size of the drive current of the heater may be adjusted using the resistor connected in parallel. Alternatively, the heater may be serially connected to a proportional current divider, and a size of the drive current of the heater may be adjusted using the proportional current divider.

In some embodiments of the present invention, the controller is a controller in a primary path of the system, the transmitter is a transmitter in the primary path of the system, and the method further includes:

after the primary path is faulty, generating, by MAC, a protection path control signal;

sending, by the MAC, the protection path control signal to a controller in a preset protection path; and

controlling, by the controller in the protection path, switch statuses of a laser and a heater in the protection path according to the received protection path control signal, where when a switch of the laser in the protection path is in an on state, the heater in the protection path is in an off state, and when a switch of the laser in the protection path is in an off state, the heater in the protection path is in an on state, so that temperature of the laser in the protection path remains stable.

In one embodiment, to ensure stable performance of the system, the protection path is usually reserved on an OLT side. Usually, a transmitter of the protection path is turned off. When the PON system detects that the primary path is faulty, the protection path is initiated, and the MAC generates the protection path control signal and sends the protection path control signal to the controller in the protection path. A specific operation performed by the controller in the protection path is similar to a specific operation performed by the controller in the primary path. Details are not described herein again.

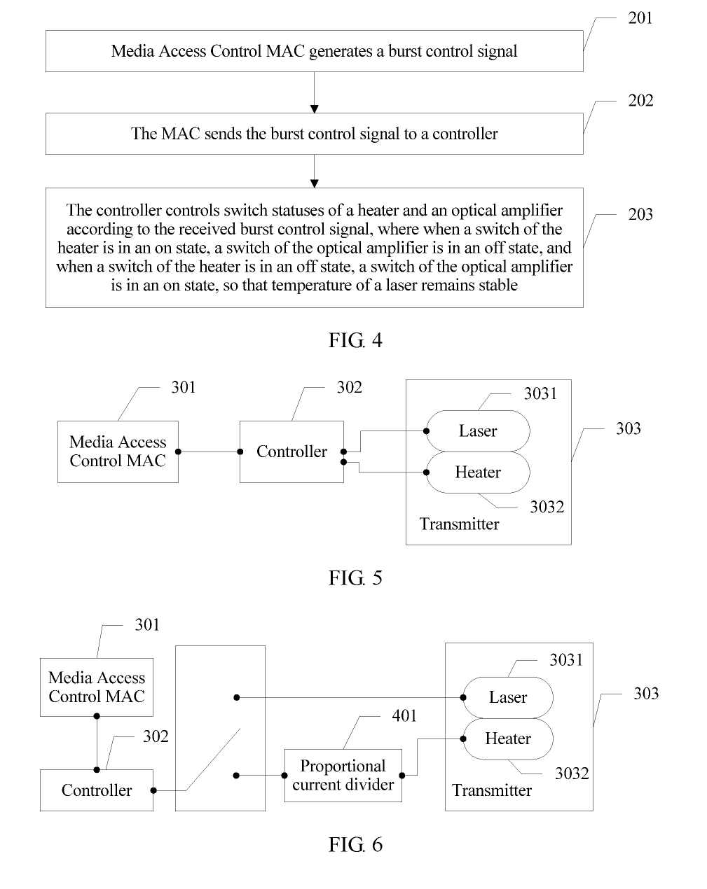

An embodiment of the present invention further provides another wavelength shift control method. Referring to FIG. 4, another embodiment of a wavelength shift control method in embodiments of the present invention includes the following operations.

Operation 201. MAC generates a burst control signal.

In one embodiment, the burst control signal of a PON system may be generated by the MAC of an ONU end based on scheduling of an OLT.

Operation 202. The MAC sends the burst control signal to a controller.

In one embodiment, there may be one or more controllers. This is not limited herein. The controller may include one or more sub-controllers, such as a laser current controller and a heater current controller.

Operation 203. The controller controls switch statuses of a heater and an optical amplifier according to the received burst control signal, where when a switch of the heater is in an on state, a switch of the optical amplifier is in an off state, and when a switch of the heater is in an off state, a switch of the optical amplifier is in an on state, so that temperature of a laser remains stable.

In one embodiment, the laser, the heater, and the optical amplifier are located in a transmitter, and the laser fits both the heater and the optical amplifier. Heat conducted by the heater to the laser when a switch of the heater is turned on to match heat conducted by the optical amplifier to the laser when a switch of the optical amplifier is turned on. For example, a ratio of a value for a drive current of the heater to a value for a drive current of the optical amplifier may be a preset threshold, to ensure that the temperature of the laser remains stable. In an actual application scenario, the optical amplifier may be added to a back end of the laser in the system. The laser works in a fixed current, and controls light output using the switch of the optical amplifier. When a current is provided for the optical amplifier, light emitted by the laser is amplified by the optical amplifier and then is transmitted. When a negative current or no current is added to the optical amplifier, light emitted by the laser is absorbed inside the optical amplifier, and cannot be transmitted through the optical amplifier.

In one embodiment, the heater and the optical amplifier alternatively work, to ensure that the temperature of the laser does not change, avoiding a wavelength shift.

An embodiment of the present invention further provides a wavelength shift control system. Referring to FIG. 5, an embodiment of the wavelength shift control system in the embodiments of the present invention includes:

MAC 301, a controller 302, and a transmitter 303, where the transmitter 303 includes a laser 3031 and a heater 3032, the laser 3031 fits the heater 3032, and heat conducted by the heater to the laser when a switch of the heater is turned on matches heat of the laser when a switch of the laser is turned off.

The MAC 301 is used to: generate a burst control signal, and send the burst control signal to the controller 302.

The controller 302 is configured to control switch statuses of the laser 3031 and the heater 3032 according to the received burst control signal, where when the switch of the laser 3031 is in an on state, the switch of the heater 3032 is in an off state, and when the switch of the laser 3031 is in an off state, the switch of the heater 3032 is in an on state, so that temperature of the laser 3031 remains stable.

In one embodiment, the burst control signal may be a pulse electrical signal. The pulse electrical signal includes two level statuses (0 and 1). Herein “0” represents a low level, and “1” represents a high level. The two level statuses respectively represent on and off states of the laser 3031.

It should be noted that the heat of the laser 3031 and the heat of the heater 3032 are both related to a drive current of the laser 3031. A larger drive current indicates more heat. The drive current of the laser 3031 is a current required for driving the laser 3031 to work. For a specific laser and a specific heater, a heat conduction relationship between the specific laser and the specific heater is determined. Therefore, as long as it is ensured that the heat conducted by the heater 3032 to the laser 3031 is consistent with the heat of the laser, it can be ensured that the temperature of the laser 3031 remains stable when the switch of the laser 3031 is turned off (the switch of the heater 3032 is turned on) and the switch of the laser 3031 is turned on (the switch of the heater 3032 is turned off). Although heat efficiency of the laser 3031 and heat efficiency of the heater 3032 are different, the heat efficiency is positively related to the drive current, for example, in direct proportion. Specifically, in some optional embodiments, to ensure that the heat of the laser 3031 is consistent with the heat of the heater 3032, it may be ensured that a drive current of the heater 3032 is proportional to the drive current of the laser 3031. To be specific, a ratio of a value for the drive current of the heater 3032 to a value for the drive current of the laser 3031 is a threshold. The threshold herein is determined based on the heat efficiency and heat conduction efficiency of the laser 3031 and the heater 3032, and the threshold is determined for the specific laser 3031 and the specific heater 3032. Specifically, FIG. 6 provides a possible schematic structural diagram of a circuit in which a drive current of a laser 3031 is proportional to a drive current of a heater 3032. In FIG. 6, Media Access Control MAC 301 is used to generate a burst control signal. A controller 302 is configured to provide a drive current. Because the current of the heater 3032 may be inconsistent with the current of the laser 3031, a current divider needs to be added to a link of the heater 3032. The current divider may be a proportional current divider 401 shown in FIG. 6.

In one embodiment, the switch of the laser 3031 and the switch of the heater 3032 are both controlled using the burst control signal, to implement stable control over temperature of the laser 3031, ensure that a transmit wavelength of the laser 3031 is stable in a burst work process of a transmitter 303 and is not shifted, and avoid impact on normal work of a PON system with a plurality of wavelength paths.

In some embodiments of the present invention, the controller 302 is specifically configured to control, according to a high or low level of the received burst control signal, switch statuses of the laser 3031 and the heater 3032.

When a level of the burst control signal is a high level, the switch of the laser 3031 is in an on state, and when a level of the burst control signal is a low level, the switch of the laser 3031 is in an off state; or when a level of the burst control signal is a low level, the switch of the laser 3031 is in an off state, and when a level of the burst control signal is a high level, the switch of the laser 3031 is in an on state.

It should be noted that when the switch of the laser 3031 is in the on state, the switch of the heater 3032 is in the off state, and when the switch of the laser 3031 is in the off state, the switch of the heater 3032 is in the on state. Refer to FIG. 3 for a specific schematic diagram of control over the burst control signal. Details are not described herein again.

In one embodiment, the switch of the laser 3031 and the switch of the heater 3032 are both controlled using the high or low level of the burst control signal, to implement the stable control over the temperature of the laser 3031, ensure that the laser 3031 and the heater 3032 alternately work, ensure that the transmit wavelength of the laser 3031 is stable in the burst work process of the transmitter 303 and is not shifted, and avoid impact on the normal work of the PON system with a plurality of wavelength paths.

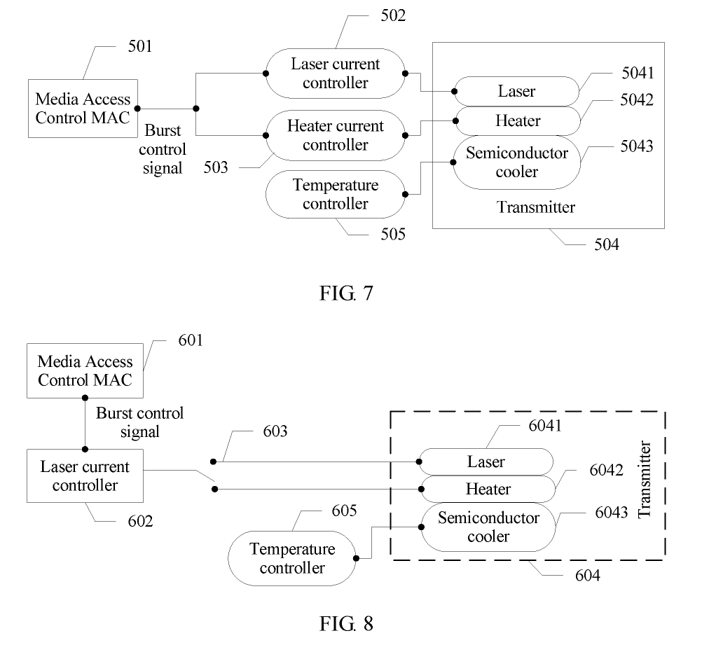

In some embodiments of the present invention, a schematic structural diagram of a possible wavelength shift control system is provided. For details, refer to FIG. 7. Media Access Control 501 generates a burst control signal, and the Media Access Control 501 sends the burst control signal to a laser current controller 502 and a heater current controller 503. The laser current controller 502 turns on a current switch of a laser 5041 in a transmitter 504 according to the received burst control signal, and the heater current controller 503 turns off a current switch of a heater 5042 in the transmitter 504 according to the received burst control signal; or the laser current controller 502 turns off a current switch of a laser 5041 according to the received burst control signal, and the heater current controller 503 turns on a current switch of a heater 5042 according to the received burst control signal. A temperature controller 505 controls a semiconductor cooler 5043 in the transmitter 504, and keeps, using the semiconductor cooler 5043, overall temperature inside the transmitter 504 unchanged through controlling.

In some embodiments of the present invention, a schematic structural diagram of another possible wavelength shift control system is provided. For details, refer to FIG. 8. Media Access Control 601 generates a burst control signal, and the Media Access Control 601 sends the burst control signal to a laser current controller 602. The laser current controller 602 switches a current switching switch 603 to an input end of a laser 6041 in a transmitter 604 according to the received burst control signal; or the laser current controller 602 switches a current switching switch 603 to an input end of a heater 6042 in the transmitter 604 according to the received burst control signal. A temperature controller 605 controls a semiconductor cooler 6043 in the transmitter 604, and keeps, using the semiconductor cooler 6043, overall temperature inside the transmitter 604 unchanged through controlling. It should be noted that in some possible implementations, the laser current controller 602 and the current switching switch 603 may be integrated inside a same component, or may be implemented using different components.

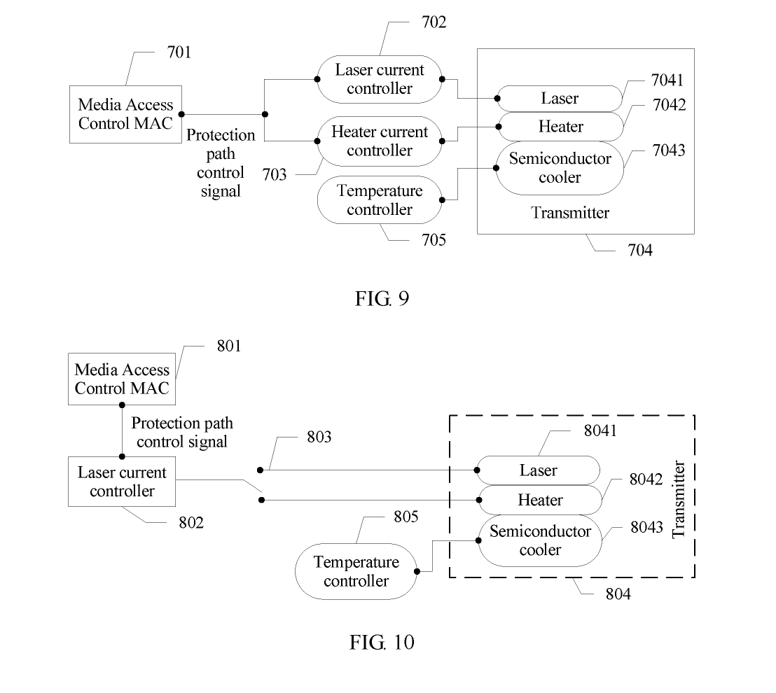

In a PON system, to ensure stable performance of the system, a protection path is usually reserved on an OLT side, and the protection path is relative to a primary path. The controller and the transmitter in the embodiments shown in FIG. 5, FIG. 6, FIG. 7, and FIG. 8 are located in the primary path. Usually, a transmitter of the protection path is turned off. When the PON system detects that the primary path is faulty, the protection path is initiated, and a controller in the protection path receives a protection path control signal output by the MAC. The controller controls switch statuses of the laser and heater in the transmitter according to the protection path control signal, so that temperature of the laser remains stable. In some embodiments of the present invention, a schematic structural diagram of a wavelength shift control system of a protection path is provided. For details, refer to FIG. 9 and FIG. 10. FIG. 9 is a schematic structural diagram similar to FIG. 7. Media Access Control 701 generates a protection path control signal, and the Media Access Control 701 sends the protection path control signal to a laser current controller 702 and a heater current controller 703. The laser current controller 702 turns on a current switch of a laser 7041 in a transmitter 704 according to the received protection path control signal, and the heater current controller 703 turns off a current switch of a heater 7042 in the transmitter 704 according to the received protection path control signal; or the laser current controller 702 turns off a current switch of a laser 7041 according to the protection path control signal, and the heater current controller 703 turns on a current switch of a heater 7042 according to the protection path control signal. A temperature controller 705 controls a semiconductor cooler 7043 in the transmitter 704, and keeps, using the semiconductor cooler 7043, overall temperature inside the transmitter 704 unchanged through controlling. Likewise, FIG. 10 is a schematic structural diagram similar to FIG. 8. Media Access Control 801 generates a protection path control signal, and the Media Access Control 801 sends the protection path control signal to a laser current controller 802. The laser current controller 802 switches a current switching switch 803 to an input end of a laser 8041 in a transmitter 804 according to the received protection path control signal; or the laser current controller 802 switches a current switching switch 803 to an input end of a heater 8042 in the transmitter 804 according to the received protection path control signal. A temperature controller 805 controls a semiconductor cooler 8043 in the transmitter 804, and keeps, using the semiconductor cooler 8043, overall temperature inside the transmitter 804 unchanged through controlling. It should be noted that in some possible implementations, the laser current controller 802 and the current switching switch 803 may be integrated inside a same component, or may be implemented using different components.

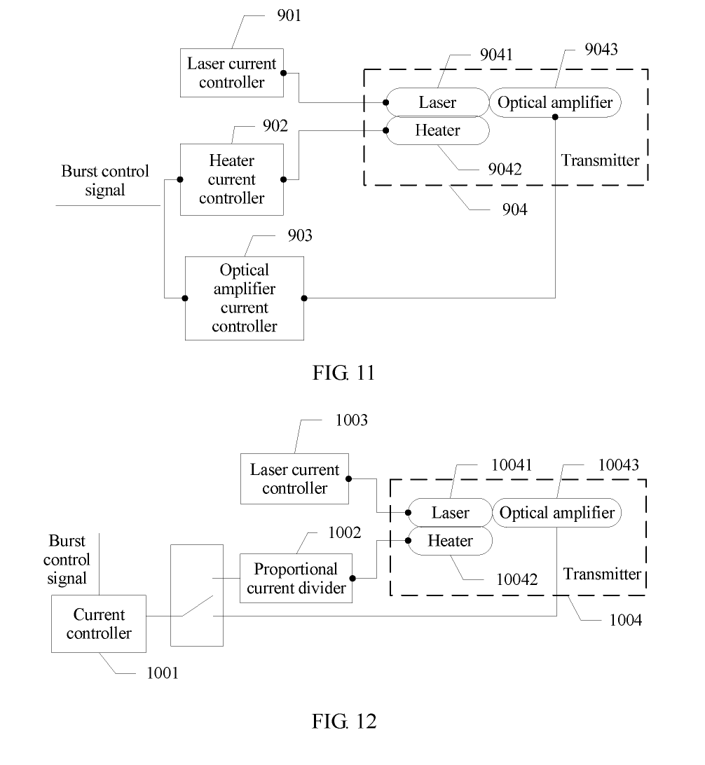

In some embodiments of the present invention, a schematic structural diagram of another possible wavelength shift control system is provided. For details, refer to FIG. 11. A laser current controller 901 provides a fixed current for a laser 9041 in a transmitter 904. A heater current controller 902 and an optical amplifier current controller 903 receive a burst control signal. The heater current controller 902 turns on a switch of a heater 9042 in the transmitter 904 according to the received burst control signal, and the optical amplifier current controller 903 turns off a switch of an optical amplifier 9043 in the transmitter 904 according to the received burst control signal; or the heater current controller 902 turns off a switch of a heater 9042 in the transmitter 904 according to the received burst control signal, and the optical amplifier current controller 903 turns on a switch of an optical amplifier 9043 in the transmitter 904 according to the received burst control signal. The laser 9041 fits both the heater 9042 and the optical amplifier 9043. Heat conducted by the heater 9042 to the laser 9041 when the switch of the heater 9042 is turned on matches heat conducted by the optical amplifier 9043 to the laser 9041 when the switch of the optical amplifier 9043 is turned on. For example, a ratio of a value for a drive current of the heater 9042 to a value for a drive current of the optical amplifier 9043 may be a preset threshold, to ensure that temperature of the laser remains stable. The heater 9042 and the optical amplifier 9043 alternatively work, to ensure that the temperature of the laser 9041 does not change, avoiding a wavelength shift. It should be noted that, to ensure that the temperature of the laser 9041 does not change, the drive current of the heater 9042 should be proportional to the drive current of the optical amplifier 9043, and a specific ratio is determined based on heat efficiency and heat conduction of the heater 9042 and the optical amplifier 9043. Specifically, FIG. 12 provides a schematic structural diagram of a possible circuit in which a drive current of a heater is proportional to a drive current of an optical amplifier. In FIG. 12, a current controller 1001 is configured to provide a drive current. A proportional current divider 1002 is configured to divide a current. A laser current controller 1003 is configured to provide a stable current for a laser 10041 in a transmitter 1004. A heater 10042 and an optical amplifier 10043 in the transmitter both adhere to the laser 10041.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented using some interfaces. The indirect couplings or communications connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the operations of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A wavelength shift control method, comprising:
generating, by a media access control (MAC) of a wavelength shift control system, a burst control signal, wherein the wavelength shift control system further includes a controller and a transmitter having a laser and a heater, wherein the laser fits the heater and heat conducted by the heater to the laser when a switch of the heater is turned on matches heat of the laser when a switch of the laser is turned off;
sending, by the MAC, the burst control signal to the controller; and
controlling, by the controller, switch statuses of the laser and the heater according to the received burst control signal, wherein when the switch of the laser is in an on state, the switch of the heater is in an off state, and when the switch of the laser is in an off state, the switch of the heater is in an on state, so that a temperature of the laser remains stable.

2. The method according to claim 1, wherein controlling, by the controller, switch statuses of the laser and the heater according to the received burst control signal comprises:
controlling, by the controller, the switch statuses of the laser and the heater according to a high or low level of the received burst control signal, wherein
when a level of the burst control signal is a high level, the switch of the laser is in the on state, and when a level of the burst control signal is a low level, the switch of the laser is in the off state; or
when a level of the burst control signal is a low level, the switch of the laser is in the off state, and when a level of the burst control signal is a high level, the switch of the laser is in the on state.

3. The method according to claim 1, wherein the controller comprises a laser current controller and a heater current controller, and wherein controlling, by the controller, switch statuses of the laser and the heater according to the received burst control signal comprises:
turning on, by the laser current controller, a current switch of the laser according to the received burst control signal, and turning off, by the heater current controller, a current switch of the heater according to the received burst control signal; or
turning off, by the laser current controller, a current switch of the laser according to the received burst control signal, and turning on, by the heater current controller, a current switch of the heater according to the received burst control signal.

4. The method according to claim 1, wherein the controller comprises a laser current controller and a current switching switch connected to the laser current controller, wherein the current switching switch is configured to connect to an input end of the laser or an input end of the heater, and wherein controlling, by the controller, switch statuses of the laser and the heater according to the received burst control signal comprises:
switching, by the laser current controller, the current switching switch to the input end of the laser according to the received burst control signal; or
switching, by the laser current controller, the current switching switch to the input end of the heater according to the received burst control signal.

5. The method according to claim 1, wherein the controller is a controller in a primary path of the system, the transmitter is a transmitter in the primary path of the system, and wherein the method further comprises:
if the primary path is faulty, generating, by the MAC, a protection path control signal;
sending, by the MAC, the protection path control signal to a controller in a preset protection path; and
controlling, by the controller in the protection path, switch statuses of a laser and a heater in the protection path according to the received protection path control signal, wherein when a switch of the laser in the protection path is in an on state, the heater in the protection path is in an off state, and when a switch of the laser in the protection path is in an off state, the heater in the protection path is in an on state, so that a temperature of the laser in the protection path remains stable.

6. The method according to claim 1, wherein the controller provides a drive current of the heater and a drive current of the laser.

7. The method according to claim 1, wherein a ratio of a value for the drive current of the heater to a value for the drive current of the laser is a preset threshold.

8. A wavelength shift control method, wherein the method is applied to a wavelength shift control system, the system comprises Media Access Control (MAC), a controller, and a transmitter, wherein the transmitter comprises a laser, a heater, and an optical amplifier, wherein the laser fits both the heater and the optical amplifier, heat conducted by the heater to the laser when a switch of the heater is turned on matches heat conducted by the optical amplifier to the laser when a switch of the optical amplifier is turned on, and wherein the method comprises:
generating, by the MAC, a burst control signal;
sending, by the MAC, the burst control signal to the controller; and
controlling, by the controller, switch statuses of the heater and the optical amplifier according to the received burst control signal, wherein when the switch of the heater is in an on state, the switch of the optical amplifier is in an off state, and when the switch of the heater is in an off state, the switch of the optical amplifier is in an on state, so that a temperature of the laser remains stable.

9. The method according to claim 8, wherein the controller provides a drive current of the heater and a drive current of the optical amplifier.

10. The method according to claim 8, wherein a ratio of a value for the drive current of the heater to a value for the drive current of the optical amplifier is a preset threshold.

11. A wavelength shift control system, comprising:
Media Access Control (MAC), a controller, and a transmitter, wherein the transmitter comprises a laser and a heater, wherein the laser fits the heater, and heat conducted by the heater to the laser when a switch of the heater is turned on matches heat of the laser when a switch of the laser is turned off,
wherein the MAC is used to: generate a burst control signal, and send the burst control signal to the controller; and
the controller is configured to control switch statuses of the laser and the heater according to the received burst control signal, wherein when the switch of the laser is in an on state, the switch of the heater is in an off state, and when the switch of the laser is in an off state, the switch of the heater is in an on state, so that a temperature of the laser remains stable.

12. The system according to claim 11, wherein the controller is configured to control the switch statuses of the laser and the heater according to a high or low level of the received burst control signal, wherein
when a level of the burst control signal is a high level, the switch of the laser is in the on state, and when a level of the burst control signal is a low level, the switch of the laser is in the off state; or
when a level of the burst control signal is a low level, the switch of the laser is in the off state, and when a level of the burst control signal is a high level, the switch of the laser is in the on state.

13. The system according to claim 11, wherein the controller comprises a laser current controller and a heater current controller, wherein the laser current controller is configured to turn on a current switch of the laser according to the received burst control signal, and the heater current controller is configured to turn off a current switch of the heater according to the received burst control signal; or the laser current controller is configured to turn off a current switch of the laser according to the received burst control signal, and the heater current controller is configured to turn on a current switch of the heater according to the received burst control signal.

14. The system according to claim 11, wherein the controller comprises a laser current controller and a current switching switch connected to the laser current controller, wherein the current switching switch is configured to connect to an input end of the laser or an input end of the heater, and wherein the laser current controller is configured to switch the current switching switch to the input end of the laser according to the received burst control signal, or the laser current controller is configured to switch the current switching switch to the input end of the heater according to the received burst control signal.

15. The system according to claim 14, wherein there is a current divider on a link of the heater.

16. The system according to claim 11, wherein the controller is a controller in a primary path of the system, the transmitter is a transmitter in the primary path of the system, wherein the MAC is further configured to: after if primary path is faulty, generate a protection path control signal, and send the protection path control signal to a controller in a preset protection path, wherein the system further comprises the controller in the protection path, and the controller in the protection path is configured to control switch statuses of a laser and a heater in the protection path according to the received protection path control signal, and wherein when a switch of the laser in the protection path is in an on state, the heater in the protection path is in an off state, and when a switch of the laser in the protection path is in an off state, the heater in the protection path is in an on state, so that a temperature of the laser in the protection path remains stable.

17. The system according to claim 11, wherein the controller provides a drive current of the heater and a drive current of the laser.

18. The system according to claim 11, wherein a ratio of a value for the drive current of the heater to a value for the drive current of the laser is a preset threshold.

19. A wavelength shift control system, comprising:
Media Access Control (MAC), a controller, and a transmitter, wherein the transmitter comprises a laser, a heater, and an optical amplifier, wherein the laser fits both the heater and the optical amplifier, and heat conducted by the heater to the laser when a switch of the heater is turned on matches heat conducted by the optical amplifier to the laser when a switch of the optical amplifier is turned on,
wherein the MAC is used to: generate a burst control signal, and send the burst control signal to the controller; and
the controller is configured to control switch statuses of the heater and the optical amplifier according to the received burst control signal, wherein when the switch of the heater is in an on state, the switch of the optical amplifier is in an off state, and when the switch of the heater is in an off state, the switch of the optical amplifier is in an on state, so that a temperature of the laser remains stable.

20. The system according to claim 19, wherein the controller provides a drive current of the heater and a drive current of the optical amplifier.
